(19) United States
(12) Patent Application Publication
(10) Pub. No.: US 2025/0095176 A1
(43) Pub. Date: Mar. 20, 2025

(54) OPTICAL PROCESSING METHOD, OPTICAL PROCESSING APPARATUS, OPTICAL PROCESSING SYSTEM, AND NON-TRANSITORY STORAGE MEDIUM STORING OPTICAL PROCESSING PROGRAM

(71) Applicant: KABUSHIKI KAISHA TOSHIBA, Tokyo (JP)

(72) Inventors: Hiroshi OHNO, Tokyo (JP); Takashi USUI, Saitama Saitama (JP)

(73) Assignee: KABUSHIKI KAISHA TOSHIBA, Tokyo (JP)

(21) Appl. No.: 18/817,826

(22) Filed: Aug. 28, 2024

(30) Foreign Application Priority Data
Sep. 19, 2023 (JP) 2023-151510

(51) Int. Cl. G06T 7/507; G06T 7/11; G06T 7/90; G06T 15/20

(52) U.S. Cl. CPC G06T 7/507; G06T 7/11; G06T 7/90; G06T 15/205; G06T 2207/20021; G06T 2207/20084

(57) ABSTRACT

According to an embodiment, an optical processing method includes: inputting an image including direction information of light from an object as hue information for each pixel into an artificial neural network; and acquiring depth information of the object for the image based on a result output from the artificial neural network.

### CROSS-REFERENCE TO RELATED APPLICATIONS

This application is based upon and claims the benefit of priority from Japanese Patent Application No. 2023-151510, filed Sep. 19, 2023, the entire contents of all of which are incorporated herein by reference.

### FIELD

Embodiments described herein relate generally to an optical processing method, an optical processing apparatus, an optical processing system, and a non-transitory storage medium storing an optical processing program.

### BACKGROUND

In various industries, inspection is performed by a method in which light is incident on an object or a medium, a change in direction (deflection) of the light with respect to an incident direction is acquired, and object information is acquired by analyzing the deflection.

### BRIEF DESCRIPTION OF THE DRAWINGS

FIG. 1 is a schematic block diagram of an optical processing system according to an embodiment.

FIG. 2 is a diagram illustrating an example of a configuration of an optical processing apparatus according to the embodiment.

FIG. 3 is a schematic diagram illustrating an optical processing flow using the optical processing apparatus according to the embodiment.

FIG. 4 is a schematic diagram illustrating an optical processing flow using the optical processing apparatus according to a first embodiment.

FIG. 5 is a schematic cross-sectional view illustrating an optical apparatus according to a second embodiment.

FIG. 6 is a diagram schematically illustrating a relationship between incident light and reflected light incident on a surface of an object and a normal vector of a surface of the object.

FIG. 7 is a schematic diagram illustrating an optical processing flow of performing optical processing on an image acquired by the optical apparatus according to the second embodiment using the optical processing apparatus according to the second embodiment.

FIG. 8 illustrates an example of an image including hue information obtained by imaging an aluminum surface using the optical apparatus.

FIG. 9 illustrates an example of a wavelength selection portion used in the optical apparatus to obtain the image illustrated in FIG. 8.

FIG. 10 illustrates an example of a three-dimensional image including depth information obtained by inputting the image illustrated in FIG. 8 to the optical processing apparatus and obtaining a solution using an artificial neural network.

FIG. 11 illustrates an inclination angle distribution of an angle α of a surface of an object S with respect to a horizontal plane based on the image illustrated in FIG. 8 and the three-dimensional image illustrated in FIG. 10.

FIG. 12 is a schematic perspective view illustrating an example of an optical apparatus in which an image formation optical element is omitted according to a third embodiment.

FIG. 13 is a schematic perspective view illustrating an example in which a wavelength selection portion of the optical apparatus illustrated in FIG. 12 is rotated by 90° with respect to an optical axis.

FIG. 14 is a schematic view illustrating an optical apparatus in which an image formation optical element is omitted and an optical processing apparatus according to a fourth embodiment.

### DETAILED DESCRIPTION

Each embodiment will be described later with reference to the drawings. The drawings are schematic or conceptual, and a relationship between a thickness and a width of each portion, a size ratio between portions, and the like are not necessarily the same as actual ones. In addition, even the same portion may be represented in the drawings differently in dimensions and ratios. In the specification and the drawings of the present application, the same reference numerals are given to the same elements as those described above with regard to the previously referenced drawings, and detailed descriptions thereof are omitted as appropriate.

It is an object of an embodiment to provide an optical processing method, an optical processing apparatus, an optical processing system, and a non-transitory storage medium storing an optical processing program capable of acquiring object information even in a case where an object shape cannot be expressed by an analytical solution of deflection.

According to the embodiment, an optical processing method includes: inputting an image including direction information of light from an object as hue information for each pixel into an artificial neural network; and acquiring depth information of the object for the image based on a result output from the artificial neural network.

According to the embodiment, an optical processing apparatus includes: a processing portion which is configured to input an image including direction information of light from an object as hue information for each pixel into an artificial neural network, and which is configured to acquire depth information of the object for the image based on a result output from the artificial neural network.

According to the embodiment, a non-transitory storage medium storing an optical processing program which causes a computer to execute: inputting an image including direction information of light from an object as hue information for each pixel into an artificial neural network; and acquiring depth information of the object for the image based on a result output from the artificial neural network.

It is known that light can be treated as electromagnetic waves by Maxwell's equations. In the present specification, the light may be visible light, X-rays, infrared rays, far infrared rays, millimeter waves, or microwaves. That is, electromagnetic waves of various wavelengths are referred to as light herein. In particular, light in a wavelength region of about 430 nm to 750 nm is referred to as visible light, and, hereinafter, visible light is used as the light.

### First Embodiment

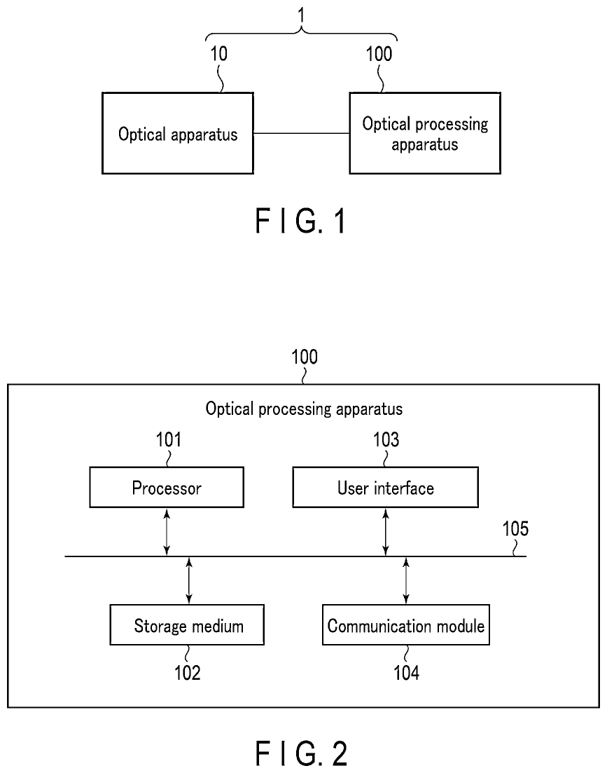

Hereinafter, an optical processing system 1 according to the present embodiment will be described with reference to FIGS. 1 to 4. The present embodiment is a modification of the optical processing system 1 of a first embodiment.

The optical processing system 1 according to the present embodiment includes an optical apparatus 10 that is configured to acquire an image Ii including direction information of light from an object S as hue information for each pixel, and an optical processing apparatus 100 that is configured to process the image Ii acquired by the optical apparatus 10. Here, the object S includes a solid, a liquid, a gel, and the like.

In the present embodiment, the image Ii acquired by the optical apparatus 10 is described as being mainly processed by the optical processing apparatus 100. However, the image Ii is not limited to the image acquired by the optical apparatus 10 according to the present embodiment, and may be any image obtained by an optical apparatus that acquires “an image Ii including direction information of light from an object as hue information for each pixel”. That is, if there is an “image Ii including direction information of light from an object as hue information for each pixel”, the optical processing apparatus 100 of the optical processing system 1 according to the present embodiment can process the image Ii input into the optical processing apparatus 100 and obtain an output (depth information for the image Ii) even without the optical apparatus 10.

FIG. 2 is a diagram illustrating an example of a configuration of the optical processing apparatus 100. The optical processing apparatus 100 is, for example, a computer. The optical processing apparatus 100 includes, for example, a processor (processing portion) 101, a storage medium 102, a user interface 103, and a communication module 104. The processor 101, the storage medium 102, the user interface 103, and the communication module 104 are connected to each other through a bus 105.

The processor 101 includes any of a central processing unit (CPU), a graphics processing unit (GPU), an application specific integrated circuit (ASIC), a microcomputer, a field programmable gate array (FPGA), a digital signal processor (DSP), and the like. The storage medium 102 may include an auxiliary storage device in addition to a main storage device such as a memory.

The main storage device is a non-transitory storage medium. The main storage device is, for example, a non-volatile memory capable of writing and reading at any time, such as a hard disk drive (HDD) or a solid state drive (SSD), a non-volatile memory such as a read only memory (ROM), or the like. In addition, these nonvolatile memories may be used in combination. The auxiliary storage device is a tangible storage medium. The auxiliary storage device used is a combination of the above-described nonvolatile memory and a volatile memory such as a random access memory (RAM). In the optical processing apparatus 100, the number of each of the processor 101 and the storage medium 102 provided may be only one or two or more.

In the optical processing apparatus 100, the processor 101 performs processing by executing a program or the like stored in a storage medium 102. Furthermore, the program executed by the processor 101 of the optical processing apparatus 100 may be stored in a computer (server) connected via a network such as the Internet, a server in a cloud environment, or the like. In this case, the processor 101 downloads the program via the network.

In the user interface 103, various operations and the like are input by a user of the optical processing apparatus 100, and information or the like to be notified to the user is notified by display or the like. The user interface 103 is a display portion such as a display, or an input portion such as a touch panel or a keyboard. Note that a device connected to the optical processing apparatus 100 may be used as the input portion, or an input portion of another processing apparatus that can communicate via a network may be used.

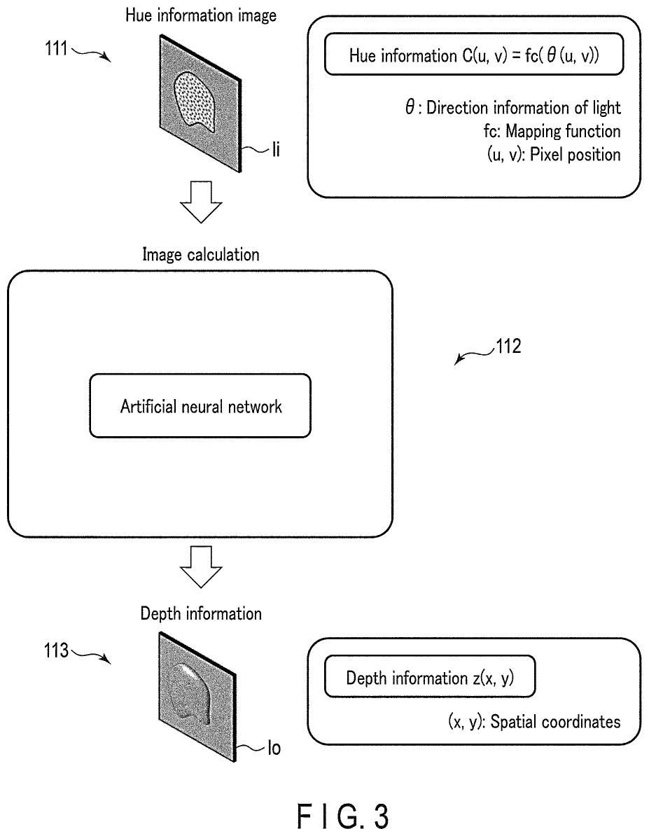

FIG. 3 illustrates a basic processing flow of optical processing using the optical processing apparatus 100 according to the present embodiment.

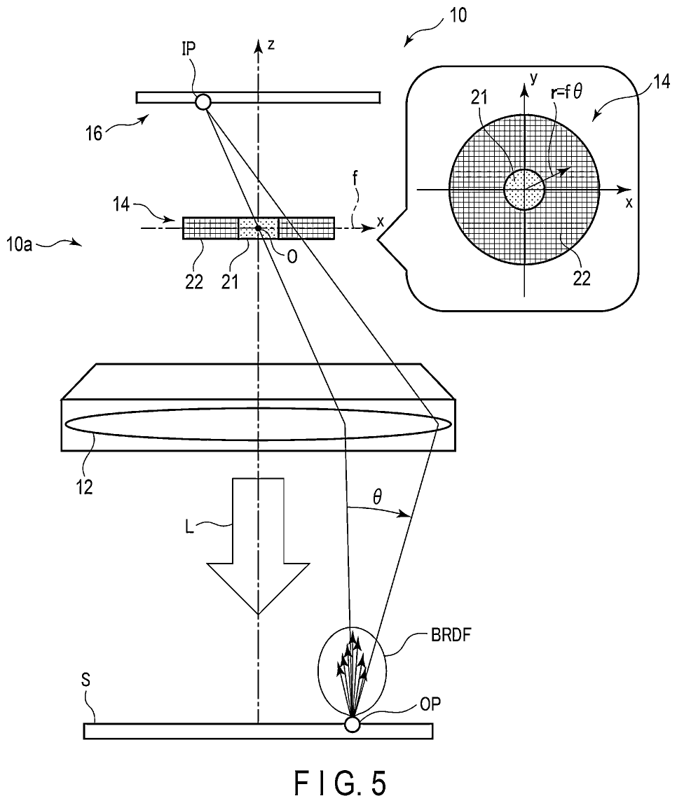

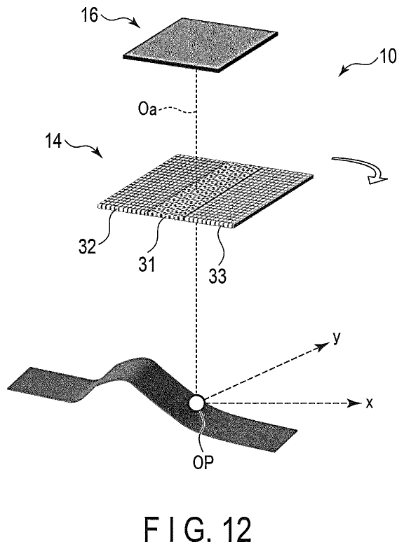

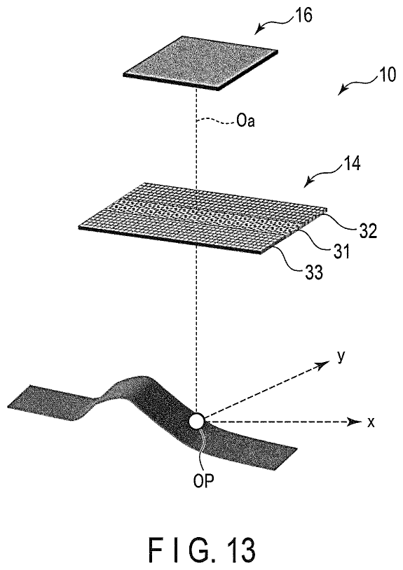

First, the optical processing apparatus 100 acquires an image (image including hue information C) Ii including direction information of light from an object as hue information for each pixel. Here, for example, as a method (optical apparatus 10) of imaging direction information of light as hue information, there is a technique related to an optical apparatus 10 illustrated in FIG. 5 according to the second embodiment which will be described later or a technique related to an optical apparatus 10 illustrated in FIGS. 12 and 13 according to the third embodiment which will be described later. The hue information image Ii has hue information for two independent parameters (u, v) representing a pixel position.

The hue information may be, for example, H (Hue) among three components of H (Hue), S (Saturation), and V (Value) in the HSV color coordinate space. However, the hue information is not limited to this, and three components of R (Red), G (Green), and B (Blue) in the RGB color coordinate space may be used. That is, the hue information may be any quantity (scalar quantity, vector quantity, tensor quantity) as long as it can express the hue. Hereinafter, this quantity is referred to as C(u, v).

The direction information of light may be, for example, an angle of a light beam with respect to a specific axis when the axis is taken as a reference. Alternatively, the direction information of light may be a two-dimensional polar coordinate representing the direction of a light beam. Alternatively, the direction information of light may be a generalized secondary coordinate representing the direction of a light beam in the curved surface coordinate. That is, the direction information of light may be any quantity (scalar quantity, vector quantity, tensor quantity) as long as it can express the direction of light. Hereinafter, this quantity is referred to as θ(u, v).

According to the technique related to an optical apparatus 10 illustrated in FIG. 5 according to the second embodiment which will be described later or the technique related to an optical apparatus 10 illustrated in FIGS. 12 and 13 according to the third embodiment which will be described later, the direction information θ(u, v) of light can be associated with the hue information C(u, v). That is, there is a mapping function fc that reflects the direction information θ of light in the hue information C. At this time, the hue information C can be represented, using the direction information θ of light, as follows: C(u, v)=fc(θ(u, v)).

The optical processing apparatus 100 according to the present embodiment includes: an acquisition portion 111 that acquires a hue information image Ii by appropriately using the processor 101, the storage medium 102, the user interface 103, the communication module 104, and the like; an image calculation portion 112 that performs calculation on the acquired hue information image Ii; and an information output portion 113 that outputs depth information and/or an image Io having the depth information.

In the image calculation portion 112 of the optical processing apparatus 100, at least a part of the information obtained from the hue information image Ii is input into an artificial neural network, and an output is obtained from the artificial neural network. The artificial neural network is a mathematical model including a large number of “neurons” connected to each other, and each neuron processes the input using “activation function” and generates an output. This network is known to have an ability to easily generate even complex functions.

The optical processing apparatus 100 itself has an algorithm of the artificial neural network, and may obtain an appropriate output using the algorithm, or may be connected to an appropriate server or the like via, for example, the user interface 103 or the communication module 104 of the optical processing apparatus 100 to obtain an appropriate output using the algorithm of the artificial neural network. That is, the optical processing apparatus 100 according to the present embodiment may output a solution using the algorithm of the artificial neural network of the optical processing apparatus 100, or may be connected to a server or the like different from the optical processing apparatus 100, output the image Ii to the server via, for example, the user interface 103 or the communication module 104, and cause the server to return the solution.

The pixel position (u, v) can be associated with a point (object point) in the imaged object. That is, they can be associated with two-dimensional spatial coordinates (x, y) on an imaging surface. However, the two-dimensional spatial coordinates (x, y) may not necessarily be spatial coordinates on an actual imaging surface. That is, any pixel positions may be used as long as they can be described by parameters (x, y) having two independent degrees of freedom. For example, (x, y) may be the same as (u, v).

The depth information is a coordinate z(x, y) of the object in a direction orthogonal to the two-dimensional spatial coordinates (x, y).

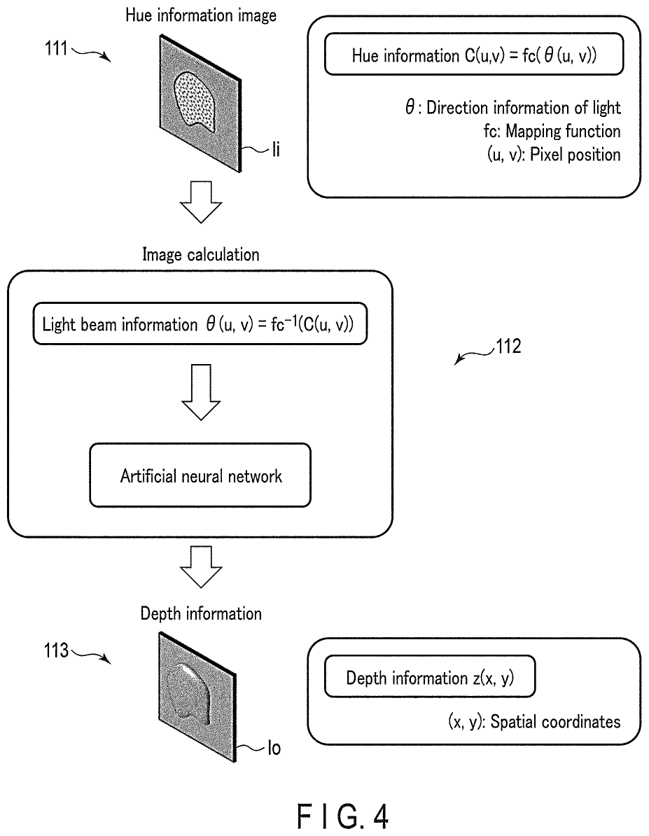

Next, a processing flow of the optical processing apparatus 100 according to the present embodiment will be described with reference to FIG. 4.

By using the direction information θ of light and the mapping function fc, the hue information C of the hue information image Ii can be represented as follows:

$$C ( u , v ) = fc ( θ ( u , v ) ) . \qquad ( 1 )$$

Thus, by using an inverse mapping function, the direction information θ of light can be calculated, from the hue information C, as follows:

$$θ ( u , v ) = f {c}^{- 1} ( C ( u , v ) ) . \qquad ( 2 )$$

In the expression, fc⁻¹ is an inverse mapping function of the mapping function fc.

The mapping function fc may be obtained in advance by a least squares method or the like, by acquiring the relationship between the direction information θ of light and the hue information C by measurement or the like and assuming a function such as a polynomial on the measurement result. However, the mapping function fc is not limited to this, and may be any function as long as it links the direction information θ of light and the hue information C.

As illustrated in FIG. 4, the image calculation portion 112 obtains direction information of light θ(u, v) from the hue information image Ii with respect to the pixel position (u, v) by using Expression (2).

The direction information of light θ(u, v) is considered to necessarily include shape information of the object S based on geometric optics. For example, when the object S is opaque and has a uniform surface property, the direction information θ of light is determined by the three-dimensional surface shape of the object S. When the object S is transparent and has uniform surface property and internal property, the direction information θ of light is determined by the three-dimensional surface shape and the three-dimensional internal shape of the object S. Even when the surface property and the internal property of the object S are not uniform, the direction information θ of light is affected by at least the three-dimensional surface shape or the three-dimensional internal shape of the object S. That is, the direction information θ of light always includes information on the three-dimensional surface shape or the three-dimensional internal shape of the object S. Hereinafter, the three-dimensional surface shape and the three-dimensional internal shape of the object S are collectively referred to simply as three-dimensional shape of the object S.

As described above, based on the geometric optics, an equation relating the direction information θ of light with the three-dimensional shape of the object S can be derived. A conventional optical processing method of acquiring an object shape from deflection (change in direction of light with respect to an incident direction) is limited to a case where the object shape can be clearly formulated by a mathematical expression as a function of deflection, that is, a case where the object shape can be represented by an analytical solution of deflection. In many cases, since the equation (function) becomes a nonlinear partial differential equation or an equation of a complicated form, it is difficult to find an analytical solution thereto. However, when the artificial neural network is used, a nonlinear partial differential equation or an equation of a complicated form can be solved. This is because the artificial neural network has a universal approximation theorem. That is, the artificial neural network can approximate an arbitrary smooth function with high accuracy. This property makes it possible to obtain a complicated solution governed by a nonlinear partial differential equation, which has been difficult in the related art.

The pixel position (u, v) can be associated with the position of an object point OP in the imaged object S, and can be expressed by two-dimensional spatial coordinates (x, y) of the object point OP. However, the two-dimensional spatial coordinates (x, y) is not limited to this, and the two-dimensional spatial coordinates (x, y) may be any coordinates as long as they are associated with the pixel position (u, v).

The three-dimensional shape of the object S is equivalent to the depth information z (x, y). In the present embodiment, the image calculation portion 112 uses an equation relating the direction information θ(u, v) of light with the three-dimensional shape z(x, y) of the object S, which is derived based on the geometric optics, and finds a solution to the equation by the artificial neural network. Then, the three-dimensional shape z(x, y) of the object S is output from the direction information θ(u, v) of light.

By the above processing, the image Io having the depth information z(x, y) of the object S can be acquired from the image Ii. In the present embodiment, the artificial neural network is used in the image calculation portion 112. As a result, even when the equation relating the direction information of light θ(u, v) with the three-dimensional shape z(x, y) of the object S is a nonlinear partial differential equation or an equation of a complicated form, the universal approximation theorem is established in the artificial neural network, so that an effect that a solution can be found according to the present embodiment is obtained.

Therefore, according to the present embodiment, an optical processing method includes: inputting the image Ii including the direction information θ of light from the object S as the hue information C for each pixel into the artificial neural network; and acquiring (the image Io having) the depth information z for the image Ii of the object S based on the result output from the artificial neural network.

According to the present embodiment, the optical processing apparatus 100 includes a processing portion (processor) 101 which is configured to input the image Ii including the direction information θ of light from the object S as the hue information C for each pixel into the artificial neural network, and which is configured to acquire the depth information z and/or the image Io having the depth information z for the image Ii of the object S based on the result output from the artificial neural network.

According to the present embodiment, the optical processing system 1 includes such an optical processing apparatus 100 and an imaging portion 10a that is configured to acquire the image Ii. The imaging portion 10a includes an image formation optical element 12, an image sensor 16, and a wavelength selection portion 14 that causes the image sensor 16 to acquire the direction information θ of light from the object S as the hue information C.

According to the present embodiment, an optical processing program causes a computer (processor) 101 to execute: inputting the image Ii including the direction information θ of light from the object S as the hue information C for each pixel into the artificial neural network; and acquiring (the image Io having) the depth information z for the image Ii of the object S based on the result output from the artificial neural network.

By using such optical processing method, optical processing apparatus 100, and optical processing program, even in a case where the object shape cannot be expressed by an analytical solution of deflection (change in direction of light with respect to the incident direction), the object information (image Io) including the three-dimensional shape z(x, y) of the object can be acquired. Note that the optical processing method, the optical processing apparatus 100, the optical processing system 1, and the optical processing program according to the present embodiment can be clearly formulated by a mathematical expression as a function of deflection, and can also be used in a case where the object shape can be expressed by an analytical solution of deflection.

### Second Embodiment

Hereinafter, an optical processing system 1 according to the present embodiment will be described with reference to FIG. 5.

FIG. 5 is a cross-sectional view illustrating an optical apparatus 10 of the optical processing system 1 according to the present embodiment. The optical apparatus 10 includes an imaging means and a processing means. An optical processing apparatus 100 of the optical processing system 1 can be the same as the optical processing apparatus 100 described in the first embodiment.

An imaging portion 10a of the optical apparatus 10 includes an image formation optical element 12, a wavelength selection portion 14, and an image sensor 16.

The image formation optical element 12 is, for example, an image forming lens. In FIG. 5, the image forming lens is schematically represented by one lens, but may be a set lens including a plurality of lenses. Alternatively, the image formation optical element 12 may be a concave mirror, a convex mirror, or a combination thereof. That is, the image formation optical element 12 may be any optical element as long as the optical element has a function of collecting light beams emitted from a point of the object S, that is, an object point OP at a conjugate image point. The phenomenon that the light beams emitted from the object point OP on a surface of the object S are collected (condensed) at an image point IP by the image formation optical element 12 is referred to as image formation. Alternatively, the image formation means that the object point OP is transferred to the image point (conjugate point of the object point) IP. A collection surface of the conjugate point to which light beams emitted from sufficiently far object point OP are transferred by the image formation optical element 12 is referred to as focal plane f of the image formation optical element 12. In addition, a line perpendicular to the focal plane f and passing through the center of the image formation optical element 12 is defined as optical axis Oa. At this time, the conjugate image point IP of the object point OP transferred by the light beams is referred to as focal point. In the present embodiment, the image formation optical element 12 is simply referred to as lens.

In the cross section illustrated in FIG. 5, it is assumed that the optical axis Oa coincides with the z axis. The optical axis Oa is included in the cross section illustrated in FIG. 5. In the present embodiment, the direction information of light is an angle θ formed by the light beams and the optical axis Oa.

It is assumed that the image sensor 16 has at least one or more pixels, and each pixel can receive at least two light beams having different wavelengths, that is, a light beam having a first wavelength and a light beam having a second wavelength. A surface including the image sensor 16 is an image surface of the image formation optical element 12. The image sensor 16 may be an area sensor or a line sensor. The area sensor is a sensor in which pixels are arrayed in an area shape in the same plane. In addition, the line sensor is formed by arraying pixels in a line shape. The image sensor 16 may include three color channels of R, G, and B in each pixel. That is, image sensor 16 may receive light in independent color channels. However, each color channel need not be completely independent, and may be substantially slightly sensitive to the same wavelength between the respective color channels.

The wavelength selection portion 14 includes, for example, a first wavelength selection region 21 and a second wavelength selection region 22. In the present embodiment, in the wavelength selection portion 14, the first wavelength selection region 21 is concentric on the inner side and the second wavelength selection region 22 is concentric on the outer side.

However, the shape of the wavelength selection portion 14 is not limited to this, and the wavelength selection portion 14 may have any shape. The first wavelength selection region 21 allows light of a first wavelength spectrum to pass therethrough and shields light of a second wavelength spectrum different from the first wavelength spectrum. However, the first wavelength selection region 21 may be any region as long as it allows light of the first wavelength spectrum to pass therethrough and shields at least a part of light of the second wavelength spectrum different from the first wavelength spectrum. Also, the second wavelength selection region 22 allows light of the second wavelength spectrum to pass therethrough and shields light of the first wavelength spectrum. However, the second wavelength selection region 22 may be any region as long as it allows light of the second wavelength spectrum to pass therethrough and shields at least a part of light of the first wavelength spectrum. Here, allowing light to pass means transmitting or reflecting light. That is, it means not shielding light. In the present embodiment, the first wavelength spectrum is, for example, blue light having a wavelength of 400 nm to 500 nm. The second wavelength spectrum is red light having a wavelength of 580 nm to 650 nm. However, the wavelength spectra are not limited to these, and may be any wavelength spectra as long as the first wavelength spectrum and the second wavelength spectrum are different from each other.

Furthermore, the wavelength selection portion 14 may further include a third wavelength selection region (not illustrated) on the outer periphery of the second wavelength selection region 22.

The wavelength selection portion 14 is arranged on the focal plane of the image forming lens 12 and is installed at a position with a focal length f from the main surface of the image forming lens 12. An origin O of orthogonal coordinates (x, y, z) is set in the wavelength selection portion 14. That is, the z axis passes through the center of the first wavelength selection region 21, and this is set as the origin O.

In the present embodiment, illumination light L from an illumination portion (not illustrated) emits parallel light along the optical axis Oa of the imaging portion. For example, in order to generate the illumination light L, the illumination portion can generate parallel light by using a white LED as a light source and using a pinhole and an illumination lens. Then, light is emitted from the light source toward the optical axis Oa, and parallel light is reflected by a half mirror or the like to illuminate the object S with parallel light (illumination light) along the optical axis Oa. Note that ON/OFF of light emission from the light source of the illumination portion is suitably controlled by the optical processing apparatus 100.

A direction distribution of reflected light from the object point OP on the surface (object surface) of the object S can be expressed by a distribution function called bidirectional reflectance distribution function (BRDF). BRDF generally changes depending on a surface state (surface property or surface shape) of the object S. For example, when the surface is rough, the reflected light spreads in various directions, so that BRDF has a wide distribution. That is, the reflected light exists over a wide angle. On the other hand, when the surface becomes a mirror surface, the reflected light is substantially only a specular reflection component, so that BRDF has a narrow distribution. Thus, BRDF reflects the surface state of the surface of the object S. In particular, BRDF generally greatly changes due to minute irregularities having a size of 10 times or less the wavelength of light.

In the present embodiment, it is assumed that the object S is opaque and that the illumination light (parallel light) L is reflected on the object surface. However, the object S is not limited to this, and the object S may be transparent or translucent. In that case, the imaging portion 10a is arranged on a side where the illumination light (parallel light) L from the illumination portion is transmitted through the object S.

Next, an operation of the optical processing system 1 including a processing flow of the optical processing apparatus 100 according to the present embodiment will be described.

The optical apparatus 10 illustrated in FIG. 5 is used to acquire, by the image sensor 16, the image Ii including the direction information θ of light through the image formation optical element 12 and the wavelength selection portion 14 having a region having at least two different transmission wavelength spectra or at least two different reflection wavelength spectra. By the optical apparatus 10 illustrated in FIG. 5, when the direction information θ of light by the reflected light of the illumination light L of the parallel light is 0, the light beam from the object point OP passes through the first wavelength selection region 21, becomes the first wavelength spectrum, and is imaged on the image sensor 16, so that the image Ii is acquired. On the other hand, when the direction information θ of light increases, the light beam from the object point OP passes through the second wavelength selection region 22, becomes the second wavelength spectrum, and is imaged on the image sensor 16, so that the image Ii is acquired. As a result, the hue information C acquired by the image sensor 16 changes depending on the magnitude of the direction information θ of light. That is, the direction information θ of light from the object S can be identified based on the hue information C acquired by the image sensor 16. That is, the image Ii including the direction information θ of light is acquired, by the image sensor 16, through the image formation optical element 12 and the wavelength selection portion 14 having a region having at least two different transmission wavelength spectra or at least two different reflection wavelength spectra.

A position vector r represents a position at which a light beam having an angle (light direction information) θ with respect to the optical axis Oa passes through the wavelength selection portion 14 when projected onto the wavelength selection portion 14. The projection position vector r on a two-dimensional plane can be derived by using the focal length f and a two-dimensional angle vector θ having two components of Ox and θy based on a geometric optical system, as follows:

$$r = f θ = f ( \begin{matrix}{θ}_{x} \\ {θ}_{y}\end{matrix} ) = f tan θ ( \begin{matrix}cos φ \\ sin φ\end{matrix} ) . \qquad ( 3 )$$

In the expression (3), φ represents an azimuth angle with respect to the x direction. The light beam direction of θ can be obtained by color mapping of one-shot BRDF by the optical apparatus 10 including the wavelength selection portion 14.

By increasing the number, shape, and the like of the wavelength selection regions of the wavelength selection portion 14, the optical processing apparatus 100 can more finely identify the direction information θ of light from the object S by the difference in hue. The quantity expressing the hue may be, for example, Hue, which can be immediately calculated from the image Ii acquired by the RGB image sensor. The mapping function fc indicates correspondence between Hue and the direction information θ of light.

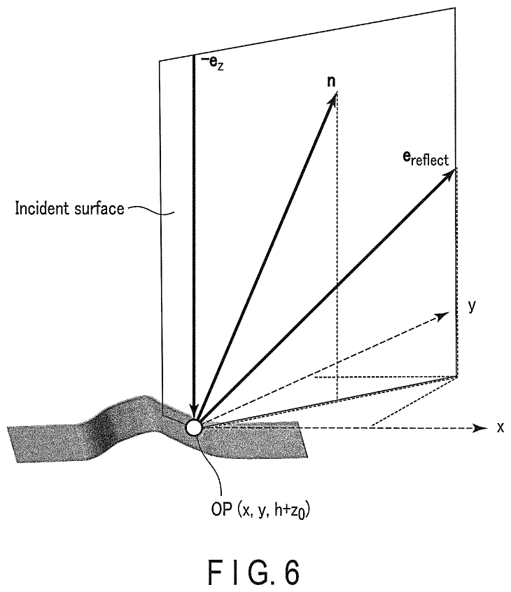

FIG. 6 is a diagram schematically illustrating a relationship between incident light and reflected light incident on the surface of the object S and a normal vector of a surface of the object. When the surface of the object is close to a mirror surface, the incident light is specularly reflected on the object surface. That is, assuming that the surface is smooth and continuous, the reflection can be approximated by specular reflection. At this time, the incident light beam and the reflected light beam are located in an incident plane. Therefore, a normal vector n at the object point OP determines the direction of the reflected light beam. Therefore, a unit vector e_{reflect} of the reflected light beam can be described, based on the law of specular reflection, as follows:

$${e}_{refl} = 2 ( n \cdot {e}_{z} ) n - {e}_{z} . \qquad ( 4 )$$

In the expression (4), e_{z} represents a unit vector in the z direction.

A height distribution of the three-dimensional surface can be described by a function z of (x, y). The coordinates of the object point are defined as (x, y, z+z₀). Here, z=z₀ represents a reference plane, and z represents depth (height).

The normal vector n of the object point OP can describe z as follows:

$$n = \frac{1}{1 + {( {\partial }_{x} z )}^{2} + {( {\partial }_{y} z )}^{2}} ( \begin{matrix}- {\partial }_{x} z \\ - {\partial }_{y} z \\ 1\end{matrix} ) . \qquad ( 5 )$$

The angle vector θ can derive the depth z using Expressions (3) to (5), as follows:

$$θ = ( \begin{matrix}{θ}_{x} \\ {θ}_{y}\end{matrix} ) = \frac{1}{1 - {( {\partial }_{x} z )}^{2} - {( {\partial }_{y} z )}^{2}} ( \begin{matrix}- 2 {\partial }_{x} z \\ - 2 {\partial }_{y} z\end{matrix} ) . \qquad ( 6 )$$

Expression (6) can be converted using Expression (3). At this time, based on the geometric optics, the following nonlinear partial differential equation is established between the depth z and the direction information θ of light:

$${( {\partial }_{x} z )}^{2} + {( {\partial }_{y} z )}^{2} = {tan}^{2} \frac{θ}{2} . \qquad ( 7 )$$

In general, the equation of Expression (7) cannot be solved analytically. Therefore, it has been conventionally difficult to solve this equation.

Expression (7) can be transformed into an equation in which the right side is 0 as in:

$${ζ}_{x , y} ( z , θ ) = {( {\partial }_{x} z )}^{2} + {( {\partial }_{y} z )}^{2} - {tan}^{2} \frac{θ}{2} = 0. \qquad ( 8 )$$

That is, the depth z can be obtained by bringing the value of ζ_{x, y}(z, θ) in Expression (8) close to 0. As in Expression (8), the right side of all the equations can be set to 0.

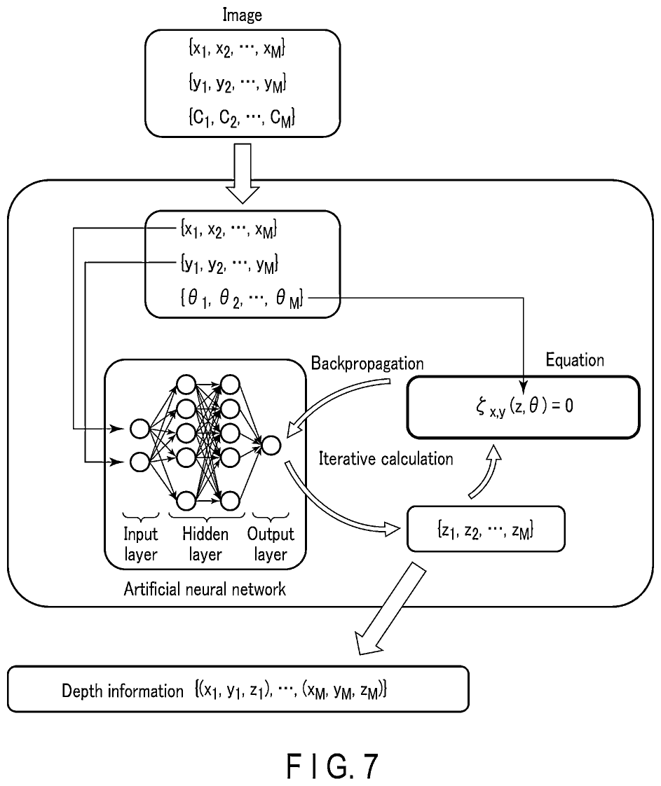

FIG. 7 illustrates a processing flow of the optical processing apparatus 100 according to the present embodiment.

Expression (8), which is a non-linear partial differential equation, can be sequentially solved using an artificial neural network.

Expression (8) is a nonlinear partial differential equation, and thus is difficult to solve in an analytical manner, but can be solved by using an equation-driven deep neural network (DNN; deep artificial neural network). The equation-driven DNN can build an analytical function without the need for training data.

Here, the hue information image Ii is C(x, y), and (x, y) are two-dimensional spatial coordinates. However, the (x, y) may be a pixel position. The pixel position and the two-dimensional spatial coordinates (x, y) can be considered to be equivalent. However, since the spatial coordinates of the image Ii are discrete, numbering is performed with subscripts. That is, (xᵢ, yᵢ) (i=1, 2, . . . , M). A loss function is ζ that can be represented by Expression (8), and is derived from two-dimensional spatial coordinates (x, y) input into the DNN and the direction information θ of light.

What is important here is that the equation-driven DNN is an unsupervised learning method and does not require data to train the DNN. Furthermore, the universal approximation theorem of a neural network states that the DNN can approximate an arbitrary smooth function with high accuracy.

The depth (height) distribution z on the 3D surface of the object S is obtained by bringing the loss function ζ close to zero. This iteratively reduces the loss function ζ using a backpropagation (error backpropagation) algorithm of the DNN. That is, the optical processing apparatus 100 involves iterative calculation so that the three-dimensional shape (image Io) of the object S output when the image Ii is input into the artificial neural network, that is, the direction information θ of light is input using the artificial neural network satisfies the equation (loss function ζ=0) derived based on the geometric optics.

For example, in the present embodiment, the DNN includes three hidden layers and one output layer. Each hidden layer includes 100 neurons. An activation function of the hidden layer is a hyperbolic tangent function, and the output layer is scaled by a sigmoid function. The total number of grids M is, for example, 65536, and the number of grids in both the x direction and the y direction is 256.

Through the above processing, (x₁, x₂, . . . , x_{M}), (y₁, y₂, . . . , y_{M}), and (θ₁, θ₂, . . . , θ_{M}) based on the information (x₁, x₂, . . . , x_{M}), (y₁, y₂, . . . , y_{M}), and (C₁, C₂, . . . , C_{M}) of the image Ii are input to the artificial neural network, and (z₁, z₂, . . . , z_{M}) is obtained, while the solution of (z₁, z₂, . . . , z_{M}) is obtained by iteratively bringing the loss function ζ close to 0 using the back propagation algorithm so as to satisfy the equation (Expression (8)) of the loss function ζ=0.

In this way, the solutions z₁(x₁, y₁) to z_{M}(x_{M}, y_{M}) are obtained as the solutions to Expression (8), and the depth information z(x, y) of the object S can be acquired.

In the present embodiment, the artificial neural network is used in the image calculation portion 112. As a result, even when the equation relating the direction information of light θ(u, v) with the three-dimensional shape z(x, y) of the object S is a nonlinear partial differential equation or an equation of a complicated form, the universal approximation theorem is established in the artificial neural network, so that an effect that a solution can be found by the optical processing apparatus 100 according to the present embodiment is obtained.

In the present embodiment, the wavelength selection portion 14 is formed concentrically. This means that the direction information θ of light with respect to the optical axis Oa can be acquired over the entire imaging visual field of the image Ii. Then, if the direction information θ of light can be acquired, the inclination angle of the object S having a surface close to a mirror surface can be calculated from the regular reflection rule. As a result, for example, the contact angle of a liquid on a solid surface can be instantaneously acquired over the entire visual field region of the image Ii. Further, there is an effect that the three-dimensional shape of the liquid can also be acquired by the optical processing apparatus 100 according to the present embodiment. That is, there is an effect that the inclination angle of the object S with respect to the optical axis Oa and the three-dimensional shape of the object S can be acquired over the entire visual field of the image Ii. That is, the depth information and/or the image Io having the depth information according to the present embodiment includes not only the depth (height) along the z axis but also the contact angle on the solid surface (placement surface of the object S), for example, and thus includes the three-dimensional shape of the object S.

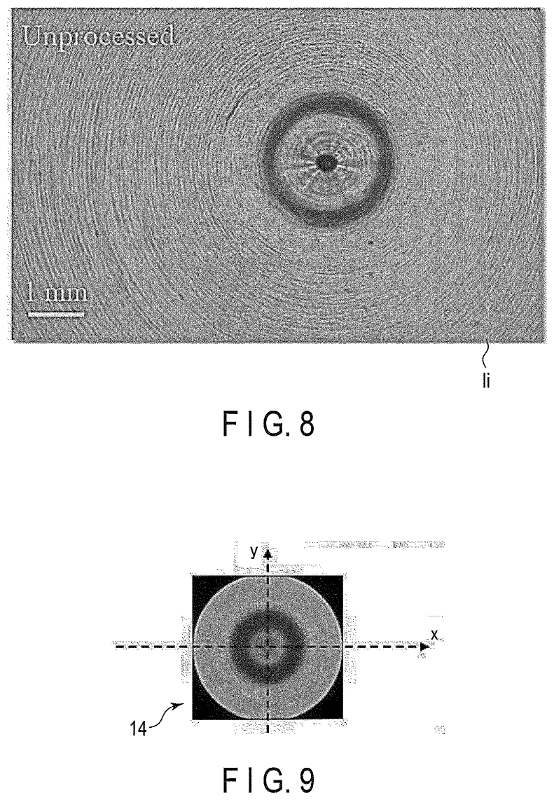

FIG. 8 illustrates an example of the image Ii including the hue information C obtained by imaging an aluminum surface using the optical apparatus 10. In this image Ii, the object shape cannot be expressed by an analytical solution of deflection. The image Ii illustrated in FIG. 8 has the hue information for each pixel.

FIG. 9 illustrates an example of the wavelength selection portion 14 used in the optical apparatus 10 to obtain the image Ii illustrated in FIG. 8. Note that the wavelength selection portion 14 illustrated in FIG. 9 is different in arrangement of the wavelength selection regions 21 and 22 from the wavelength selection portion 14 illustrated in FIG. 5. The wavelength selection portion 14 illustrated in FIG. 9 associates the hue information of the image Ii illustrated in FIG. 8 with the direction information θ of light.

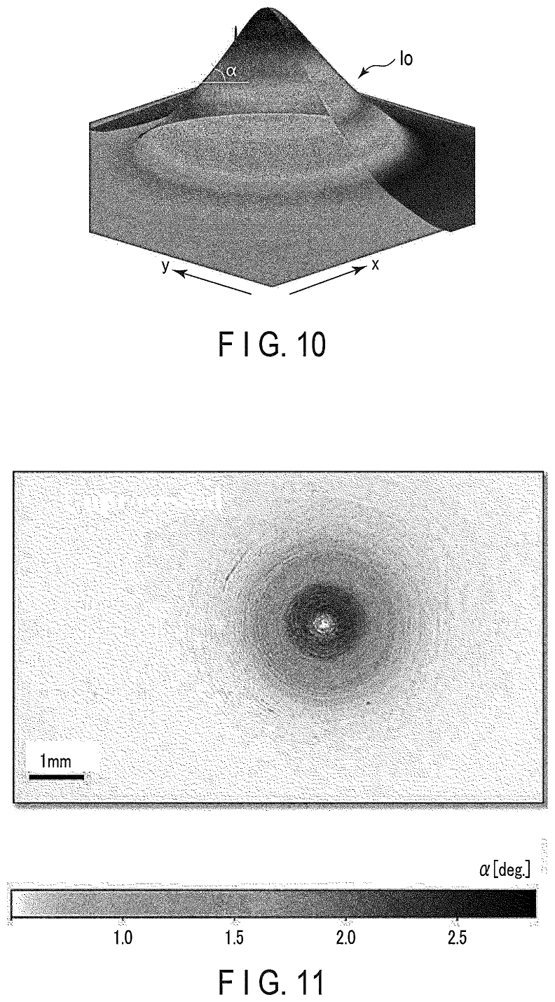

FIG. 10 illustrates an example of a three-dimensional image Io including depth information obtained by inputting the image Ii illustrated in FIG. 8 into the optical processing apparatus 100 according to the present embodiment and obtaining a solution using an artificial neural network. FIG. 11 illustrates an inclination angle distribution of an angle α of the surface of the object S with respect to a horizontal plane based on the image Ii illustrated in FIG. 8 and the three-dimensional image Io illustrated in FIG. 10.

As described above, based on the image Ii (see FIG. 8) obtained by the optical apparatus 10 of the optical processing system 1 according to the present embodiment, the object information regarding the depth information such as the angle (see FIGS. 10 and 11) with respect to the horizontal plane at each position of the object S can be acquired.

Therefore, the present embodiment can provide an optical processing method, an optical processing apparatus 100, an optical processing system 1, and an optical processing program capable of acquiring object information even in a case where the object shape cannot be expressed by an analytical solution of deflection (change in direction of light with respect to an incident direction).

### Third Embodiment

Hereinafter, an optical processing system 1 according to the present embodiment will be described with reference to FIGS. 12 and 13.

A basic part of the optical processing system 1 according to the present embodiment is the same as that of the optical processing system 1 according to the second embodiment, but a difference will be described below.

FIGS. 12 and 13 are perspective views of an optical apparatus 10 of the optical processing system 1 according to the present embodiment. An image formation optical element 12 (see FIG. 5) disposed between a wavelength selection portion 14 and an object S in the optical apparatus 10 of FIGS. 12 and 13 is not illustrated.

A wavelength selection portion 14 of the present embodiment is formed in a stripe shape. That is, the wavelength selection portion 14 of the optical apparatus 10 according to the present embodiment is not concentric. The wavelength selection portion 14 includes, for example, a first wavelength selection region 31, a second wavelength selection region 32, and a third wavelength selection region 33.

The first wavelength selection region 31 allows light of a first wavelength spectrum to pass therethrough and shields light of a second wavelength spectrum different from the first wavelength spectrum and light of a third wavelength spectrum different from the first wavelength spectrum. However, the first wavelength selection region 31 may be any region as long as it allows light of the first wavelength spectrum to pass therethrough and shields wavelengths not included in the first wavelength spectrum. The second wavelength selection region 32 allows light of the second wavelength spectrum to pass therethrough and shields light of the first wavelength spectrum and light of the third wavelength spectrum. However, the second wavelength selection region 32 may be any region as long as it allows light of the second wavelength spectrum to pass therethrough and shields wavelengths not included in the second wavelength spectrum. The third wavelength selection region 33 allows light of the third wavelength spectrum to pass therethrough and shields light of the first wavelength spectrum and light of the second wavelength spectrum. However, the third wavelength selection region 33 may be any region as long as it allows light of the third wavelength spectrum to pass therethrough and shields wavelengths not included in the third wavelength spectrum. Note that the first wavelength spectrum is, for example, blue light having a wavelength of 400 nm to 500 nm. The second wavelength spectrum is, for example, red light having a wavelength of 580 nm to 650 nm. The third wavelength spectrum is, for example, green light having a wavelength of 480 nm to 600 nm.

FIGS. 12 and 13 are different from each other in arrangement of the wavelength selection portion 14. The wavelength selection portion 14 in FIG. 13 is rotated by 90° around an optical axis Oa with respect to the wavelength selection portion 14 illustrated in FIG. 12. In FIG. 12, a direction in which the wavelength selection regions 31, 32, and 33 change is an x-axis direction. That is, each of the wavelength selection regions 31, 32, and 33 illustrated in FIG. 12 has, for example, a rectangular shape elongated in a y-axis direction. On the other hand, in FIG. 13, a direction in which the wavelength selection regions 31, 32, and 33 change is the y-axis direction. That is, each of the wavelength selection regions 31, 32, and 33 illustrated in FIG. 13 has, for example, a rectangular shape elongated in the x-axis direction.

Note that the optical apparatus 10 includes, for example, an actuator such as a motor that rotates and stops the wavelength selection portion 14 around the axis of the z axis (optical axis Oa) to a position illustrated in FIG. 12 and a position illustrated in FIG. 13. Such an actuator is suitably controlled by the optical processing apparatus 100.

Next, an operation of the optical processing system 1 according to the present embodiment will be described.

In the present embodiment, the optical processing system 1 causes the optical apparatus 10 to acquire at least one image, when the wavelength selection portion 14 of the optical apparatus 10 is in each of the arrangement illustrated in FIG. 12 and the arrangement illustrated in FIG. 13 with respect to the object point OP of the same object S. That is, at least one hue information image Ii is acquired in each arrangement, and a total of two images Ii are acquired.

In the hue information image Ii acquired by the optical apparatus 10 in the case of FIG. 12, an angle θx formed with the z axis (optical axis) of a light beam when the light beam is projected on the xz plane is associated with the hue. On the other hand, in the hue information image Ii acquired by the optical apparatus 10 in the case of FIG. 13, an angle θy formed with the z axis (optical axis) of a light beam when the light beam is projected on the yz plane is associated with the hue. At this time, assuming that depth information is z and a surface of the object is substantially a mirror surface, the following equation is obtained by geometric optics:

$${ζ}_{x , y} ( z , {θ}_{x} , {θ}_{y} ) = \frac{1}{1 - {( {\partial }_{x} z )}^{2} - {( {\partial }_{y} z )}^{2}} ( \begin{matrix}- 2 {\partial }_{x} z \\ - 2 {\partial }_{y} z\end{matrix} ) - ( \begin{matrix}{θ}_{x} \\ {θ}_{y}\end{matrix} ) = 0. \qquad ( 9 )$$

The artificial neural network can also be solved by simultaneously solving these two equations represented by Expression (9). That is, the artificial neural network may iteratively calculate the solutions of the two equations of Expression (9) assuming that the loss function ζ_{x, y}=0 is satisfied. At this time, two hue information images Ii are input into the artificial neural network. That is, the number of hue information images Ii input into the artificial neural network is not limited to one, and may be two or more.

As described above, there is an effect that the errors caused by the optical apparatus 10 at the time of acquiring the image Ii can be alleviated by simultaneously inputting the two images Ii into the artificial neural network and obtaining the depth information z. That is, for example, there is an effect that the errors are reduced because the errors are averaged when output is performed using also the image having the small error, as compared with when output is performed using only the image having the large error, among the two images Ii.

That is, by increasing the hue information image Ii to be input, there is an effect that errors of the solution of (z₁, z₂, . . . , z_{M}) (three-dimensional shape (image Io) of the object S) based on the image Ii are reduced.

The present embodiment has an effect of functioning as the optical processing system 1 that acquires the depth information z of the object S. Therefore, the present embodiment can provide an optical processing method, an optical processing apparatus 100, an optical processing system 1, and an optical processing program capable of acquiring object information even in a case where the object shape cannot be expressed by an analytical solution of deflection (change in direction of light with respect to an incident direction).

### Fourth Embodiment

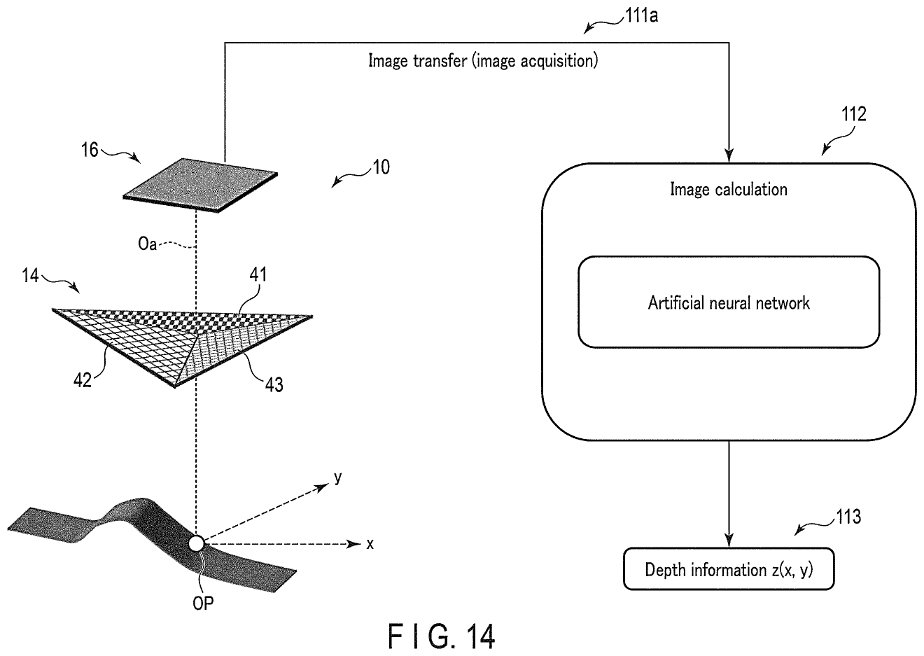

Hereinafter, an optical processing system 1 according to the present embodiment will be described with reference to FIG. 14.

A basic part of the optical processing system 1 according to the present embodiment is the same as those of the optical processing systems 1 according to the second and third embodiments, but a difference will be described below.

FIG. 14 is a perspective view of an optical apparatus 10 of the optical processing system 1 according to the present embodiment, and illustrates an optical processing flow. An image formation optical element 12 (see FIG. 5) disposed between a wavelength selection portion 14 and an object S in the optical apparatus 10 of FIG. 14 is not illustrated.

A wavelength selection portion 14 of the present embodiment has anisotropy in an azimuth angle direction. That is, the wavelength selection portion 14 is not concentric. The wavelength selection portion 14 includes a first wavelength selection region 41, a second wavelength selection region 42, and a third wavelength selection region 43. An outer shape of the wavelength selection portion 14 is a triangle, but may be any shape such as a circle or a rectangle.

The first wavelength selection region 41 allows light of a first wavelength spectrum to pass therethrough and shields light of a second wavelength spectrum different from the first wavelength spectrum and light of a third wavelength spectrum different from the first wavelength spectrum. However, the first wavelength selection region 41 may be any region as long as it allows light of the first wavelength spectrum to pass therethrough and shields light of wavelengths not included in the first wavelength spectrum. The second wavelength selection region 42 allows light of the second wavelength spectrum to pass therethrough and shields light of the first wavelength spectrum and light of the third wavelength spectrum. However, the second wavelength selection region 42 may be any region as long as it allows light of the second wavelength spectrum to pass therethrough and shields light of wavelengths not included in the second wavelength spectrum. The third wavelength selection region 43 allows light of the third wavelength spectrum to pass therethrough and shields light of the first wavelength spectrum and light of the second wavelength spectrum. However, the third wavelength selection region 43 may be any region as long as it allows light of the third wavelength spectrum to pass therethrough and shields light of wavelengths not included in the third wavelength spectrum. Note that the first wavelength spectrum is, for example, blue light having a wavelength of 400 nm to 500 nm. The second wavelength spectrum is, for example, red light having a wavelength of 580 nm to 650 nm. The third wavelength spectrum is, for example, green light having a wavelength of 480 nm to 600 nm.

The z axis (optical axis Oa) passes through the center of the wavelength selection portion 14, for example. The wavelength selection portion 14 according to the present embodiment has three wavelength selection regions 41, 42, and 43, and suitably has a central angle of 120°. Note that, even in a case where the wavelength selection portion 14 has three wavelength selection regions 41, 42, and 43, all the central angles may be different.

Furthermore, the central angle is changed according to the number of wavelength selection regions of the wavelength selection portion 14.

The optical processing system 1 according to the present embodiment includes an optical processing apparatus 100, and the optical processing apparatus 100 is the same as the optical processing apparatus 100 described in the first embodiment.

Furthermore, the optical processing apparatus 100 according to the present embodiment includes an image transfer portion 111a that transfers an image Ii acquired by an image sensor 16. The image transfer portion 111a can be used similarly to the acquisition portion 111 described in the first embodiment.

In addition, the optical processing apparatus 100 may also include a graphical user interface (GUI) or the like, but which is not illustrated in the optical processing system 1 illustrated in FIG. 14.

Next, an operation of the optical processing system 1 according to the present embodiment will be described.

As described in the third embodiment, in the present embodiment, the optical processing system 1 causes the optical apparatus 10 to acquire at least one image, when the wavelength selection portion 14 of the optical apparatus 10 is in the arrangement illustrated in FIG. 14 and rotated by each of 60° and 180° around the axis of the optical axis Oa relative to the arrangement illustrated in FIG. 14, with respect to the object point OP of the same object S. That is, at least one hue information image Ii is acquired in each arrangement, and a total of three images Ii are acquired.

By making the wavelength selection portion 14 anisotropic, there is an effect that the direction information θ of light regarding the azimuthal angle direction can be acquired based on the image Ii. In addition, there is an effect that more information regarding the azimuth angle direction can be acquired by acquiring images while rotating the wavelength selection portion around the axis of the optical axis Oa.

For example, by rotating the wavelength selection portion 14 around the axis of the optical axis Oa in accordance with the angle of the central angle of each of the wavelength selection regions 41, 42, and 43, obtaining the image Ii each time, for example, inputting the three images Ii simultaneously into the artificial neural network, and obtaining the depth information z, there is an effect that the errors caused by the optical apparatus 10 at the time of obtaining the images Ii can be alleviated. That is, for example, there is an effect that the errors are reduced because the errors are averaged when output is performed using also the images having a small error, as compared with when output is performed using only the image having a large error, among the three images Ii.

The present embodiment has an effect of functioning as the optical processing system 1 that acquires the depth information z of the object S. Therefore, the present embodiment can provide an optical processing method, an optical processing apparatus 100, an optical processing system 1, and an optical processing program capable of acquiring object information even in a case where the object shape cannot be expressed by an analytical solution of deflection (change in direction of light with respect to an incident direction).

The optical processing method, the optical processing apparatus 100, the optical processing system 1, and the optical processing program of at least one embodiment described above make it possible to acquire the object information even in a case where the object shape cannot be expressed by an analytical solution of deflection (change in direction of light with respect to an incident direction).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical processing method comprising:
inputting an image including direction information of light from an object as hue information for each pixel into an artificial neural network; and
acquiring depth information of the object for the image based on a result output from the artificial neural network.

2. The optical processing method according to claim 1, further comprising:
performing iterative calculation so that a three-dimensional shape of the object output when the direction information of the light is input using the artificial neural network satisfies an equation derived based on geometric optics.

3. The optical processing method according to claim 1, wherein:
the direction information of the light is an angle of a light beam with respect to a specific axis as a reference.

4. The optical processing method according to claim 1, further comprising:
acquiring, by an image sensor, the image including the direction information of the light through an image formation optical element and a wavelength selection portion including a plurality of regions including at least two different transmission wavelength spectra or at least two different reflection wavelength spectra.

5. An optical processing apparatus comprising:
a processing portion which is configured to input an image including direction information of light from an object as hue information for each pixel into an artificial neural network, and which is configured to acquire depth information of the object for the image based on a result output from the artificial neural network.

6. An optical processing system comprising:
the optical processing apparatus according to claim 5; and
an imaging portion which is configured to acquire the image,
wherein the imaging portion comprises:
an image formation optical element,
an image sensor, and
a wavelength selection portion that causes the image sensor to acquire direction information of light from the object as hue information.

7. The optical processing system according to claim 6, wherein
the wavelength selection portion is disposed at a focal plane of the image formation optical element.

8. The optical processing system according to claim 6, wherein:
the wavelength selection portion includes a plurality of regions including at least two different transmission wavelength spectra or at least two different reflection wavelength spectra, and
the plurality of regions are arranged concentrically.

9. The optical processing system according to claim 6, wherein:
the wavelength selection portion includes a plurality of regions having at least two different transmission wavelength spectra or at least two different reflection wavelength spectra, and
the plurality of regions are arranged in stripes.

10. A non-transitory storage medium storing an optical processing program which causes a computer to execute:
inputting an image including direction information of light from an object as hue information for each pixel into an artificial neural network; and
acquiring depth information of the object for the image based on a result output from the artificial neural network.
